(19) United States
(12) Patent Application Publication
(10) Pub. No.: US 2024/0247130 A1
(43) Pub. Date: Jul. 25, 2024

(54) ORGANOSILANE-MODIFIED ORGANIC FILLERS AND RUBBER COMPOSITIONS CONTAINING SAID FILLERS

(71) Applicant: Suncoal Industries GmbH, Ludwigsfelde (DE)

(72) Inventors: Jacob Podschun, Ludwigsfelde (DE); Gerd Schmaucks, Ludwigsfelde (DE); Tobias Wittmann, Ludwigsfelde (DE); Bernhard Schwaiger, Erftstadt (DE)

(73) Assignee: Suncoal Industries GmbH, Ludwigsfelde (DE)

(21) Appl. No.: 18/561,809

(22) PCT Filed: May 19, 2022
(86) PCT No.: PCT/EP2022/063658

§ 371 Date: Nov. 17, 2023

(30) Foreign Application Priority Data
May 20, 2021 (EP) 21174918.9

(51) Int. Cl. C08K 9/06; B60C 1/00; C08K 3/06; C08K 3/22; C08K 5/14; C08L 7/00; C08L 9/00; C08L 97/00

(52) U.S. Cl. CPC C08K 9/06; B60C 1/0008; B60C 1/0016; B60C 1/0025; C08K 3/06; C08K 3/22; C08K 5/14; C08L 7/00; C08L 9/00; C08L 97/005; C08K 2003/2296; C08K 2201/006

(57) ABSTRACT

The present invention relates to an organic filler, wherein a covalent bonding of at least one organic modifier to the organic filler has been effected at least via a part of the oxygen atoms of at least one functional group of the filler which is selected from phenolic OH groups, phenolate groups, aliphatic OH groups, carboxylic acid groups, carboxylate groups and mixtures thereof, a rubber composition comprising at least one rubber and at least the filler mentioned hereinabove, a vulcanizable rubber composition that additionally comprises a vulcanization system, a vulcanized rubber composition obtainable therefrom, as well as a use of the filler mentioned hereinabove for the production of (vulcanizable) rubber compositions for employment in the production of tires, preferably pneumatic tires and solid tires, preferably for the tread, sidewall and/or inner liner thereof, respectively, and/or for employment in the production of technical rubber articles, preferably profiles, seals, dampers and/or hoses.

The present invention relates to an organic filler, wherein a covalent bonding of at least one organic modifier to the organic filler has been effected at least via a part of the oxygen atoms of at least one functional group of the filler which is selected from phenolic OH groups, phenolate groups, aliphatic OH groups, carboxylic acid groups, carboxylate groups and mixtures thereof, a rubber composition comprising at least one rubber and at least the filler mentioned hereinabove, a vulcanizable rubber composition that additionally comprises a vulcanization system, a vulcanized rubber composition obtainable therefrom, as well as a use of the filler mentioned hereinabove for the production of (vulcanizable) rubber compositions for employment in the production of tires, preferably pneumatic tires and solid tires, preferably for the tread, sidewall and/or inner liner thereof, respectively, and/or for employment in the production of technical rubber articles, preferably profiles, seals, dampers and/or hoses.

### State of the Art/Background of the Invention

The employment of reinforcing fillers in rubber compositions is known in the prior art. In particular, industrial carbon blacks such as furnace carbon blacks should be mentioned here that are used for this purpose. Industrial carbon blacks continue to represent the largest amount of reinforcing fillers. Industrial carbon blacks are produced on the basis of highly aromatic petrochemical oils by means of incomplete combustion or pyrolysis of hydrocarbons. From an environmental point of view, it is however desirable to avoid the use of fossil energy sources for the production of fillers, or to reduce it to a minimum. It is particularly serious to note here that for the production of one ton of industrial carbon black about 1 ton of CO₂ is released in the production process, depending on the specific surface area of the carbon black. In addition, industrial carbon blacks may often not be usable for certain applications for color reasons.

A known alternative for the employment of industrial carbon blacks as reinforcing fillers are precipitated silicic acids or silica.

Precipitated silicic acids or silica are often employed in chemically modified form. Corresponding processes for surface modification with functional organosilanes, in particular, are known, for example, from DE 2513608 A1, DE 3437473 A1, DE 10122269 A1 and DE 4004781 A1 as well as from DE 10 2013 226 162 A1. Such a modification can, for example, be carried out with the aid of a gas as described in DE 10122269 A1, which is, however, comparatively costly and not economically viable. Modification of the silicic acids or silicas in a liquid medium such as a hydrocarbon, e.g., n-hexane, is also disadvantageous, since subsequent separation of the liquid in sufficient quantities often causes major problems. In general, a silanization that has to be carried out in a separate reaction step is not advantageous or often problematic in the case of silicic acids/silica, since the silicic acids are usually present in agglomerates and therefore their surface cannot be silanized to a sufficient extent because only the accessible surface of the agglomerates is silanized, which then later, when the agglomerates of the silicic acids break up (de-agglomeration) during incorporation into a rubber composition and interaction with the rubbers, often leads to problems, as the non-silanized silicic acid particles then agglomerate again in the composition, which can lead to an undesirable high viscosity and impairment of performance. In the tire and rubber industry, therefore, the modification of the silicic acids or silica with organosilanes is usually performed in situ within the rubber composition, at the latest during vulcanization. The reasons for carrying out the process in situ are a comparatively well controllable chemical modification reaction in the internal mixers used and a silanization reaction running in parallel to a de-agglomeration of the silica, which avoids the above-mentioned disadvantages.

Due to their high specific surface area, the chemically modified precipitated silicic acids are particularly suitable for use as reinforcing fillers. Therefore, corresponding precipitated silicic acids are advantageously suited for applications both in the field of technical rubber goods as well as in the tire industry. In the field of technical rubber goods, organosilanes can be used to modify the silicic acids, particularly if the polymers used have sufficiently high thermal stability for an in-situ reaction to take place. This usually requires temperatures of at least 140° C. or 150° C. In case an in-situ silanization cannot be carried out in an internal mixer because the necessary temperatures cannot be reached in the rubber compound, or the mixing times are uneconomical, an ex-situ modified (silanized) precipitated silicic acid can be used as an alternative.

In the tire industry, the use of corresponding chemically modified and, in particular, silanized precipitated silicic acids is also advantageous. Vehicle tires, like pneumatic vehicle tires, have a complex structure. Correspondingly, the demands placed on them are diverse. On the one hand, short braking distances must be ensured on dry and in particular wet roads, and they must have good abrasion properties and low rolling resistance on the other hand. In addition, the vehicle tires must comply with the requirements of legislation. To ensure such a diverse performance profile, the individual tire components are specialized and consist of a plurality of different materials, such as metals, polymer textile materials and various rubber-based components. In particular, the tread of the tires is essentially responsible for the driving characteristics. In this context, the rubber composition of the treads determines the aforementioned characteristics, such as rolling resistance, wet grip and abrasion, in particular. The requirements profile for rubber compositions that are in particular suitable for the production of treads is therefore especially high, not only in terms of the rubbers to be used, but also in particular in terms of the fillers to be used in them. In this context, the treads formed from such compositions also need to be compatible with the adjacent tire parts and especially need to have good adhesion to those.

In tire tread rubber compositions for employment in the passenger car sector, the use of silanized precipitated silicic acids as reinforcing fillers compared with industrial carbon blacks improves rolling resistance due to a chemical bonding between the precipitated silicic acid and the elastomer of the rubber composition, and at the same time improves wet grip due to the polarity at the surface of the precipitated silicic acids. Although tire abrasion is generally worse when precipitated silicic acid is used compared with industrial carbon blacks, this can be counteracted by a suitable choice of the elastomers employed (e.g., by using polybutadiene).

In tire tread rubber compositions for employment in the truck sector, however, the use of silanized precipitated silicic acids as reinforcing fillers does not achieve the required abrasion resistance as compared with industrial carbon blacks, especially since the aforementioned flexibility in the choice of elastomers, as in the case of passenger car tires, is not given here, because predominantly natural rubbers are used for truck treads.

Another disadvantage of the use of chemically modified and, in particular, silanized precipitated silicic acids in rubber compositions, especially for the production of tire treads in both the passenger car and truck sectors, is that stress values with the occurrence of small deformations are lower than with the use of industrial carbon blacks. The disadvantage is particularly evident in the case of dynamic cyclic deformations, as can occur in tires. Therefore, in order to adjust special tire characteristics of driving dynamics, the additional use of industrial carbon blacks is necessary, which, however, is undesirable for the reasons mentioned hereinabove.

In addition, both in the technical rubber articles sector and in the tire industry, rubber compounds are often used in which the specific surface areas of the precipitated silicic acids used are comparatively high, for example in a range of BET 100 to 250 m²/g. Although less heat is emitted during mechanical deformation (hysteresis) when used in passenger car treads, which improves rolling resistance, an advantage over industrial carbon blacks, which usually have a much lower specific surface area in the range of BET 30 to 50 m²/g, is then often no longer visible. In addition, the dynamic stiffness is often lower than that of rubber compounds containing industrial carbon blacks as reinforcing fillers.

Furthermore, it is also known to use lignin-based biologically regrowing raw materials, such as lignins in hydrothermally carbonized form (HTC lignin), as organic fillers in rubber compositions. These represent an environmentally friendly filler alternative compared to inorganic and organic fillers, in particular compared to industrial carbon blacks.

EP 3 470 457 A1 describes rubber compounds containing HTC lignin. The disadvantage of using such HTC lignins in rubber compositions, however, is often that the compatibility between the comparatively polar HTC lignins and the comparatively non-polar rubbers is often too low or insufficient. In addition, disadvantages are often observed with regard to the aging resistance and long-term stability of the rubber compositions containing HTC lignin, also and especially in vulcanized form, because undesirable reactions can take place due to an excessive proportion of free OH groups contained in the HTC lignins, which have a detrimental effect on aging resistance and long-term stability.

In the field of the production of rubber compositions for use in tires in general, among other things, WO 2017/085278 A1 discloses the use of particulate carbon material, in particular also of HTC lignin, as a filler substitute for industrial carbon blacks. This is associated with the same frequently occurring disadvantages mentioned hereinabove in connection with EP 3 470 457 A1. In addition, WO 2017/085278 A1 also describes that this material can be subjected to in-situ modification with organosilanes as coupling reagents after incorporation into a rubber composition. However, the disadvantage of using such organosilanes for modifying carbon materials as described in WO 2017/085278 A1 is that—as in the case of silanization of silicic acids—the modification is only carried out in situ within the rubber composition produced or, if necessary, during its vulcanization, since this often limits to an undesirable extent the degrees of freedom in the production of the composition and the constituents contained therein, especially when the carbon materials mentioned hereinabove are used in combination with other fillers such as, in particular, inorganic fillers such as, e.g., silicic acids/silicas. In particular, in the case of the aforementioned in-situ modification, the use of a silanized carbon material such as HTC lignin as a partial substitute for silanized silicic acid is not readily possible or is significantly more difficult, since the silanization of HTC lignin and silicic acid does not or cannot proceed simultaneously, but under different reaction conditions, since in particular the reaction kinetics of the bonding of the silane are very different in each case.

Finally, WO 2017/194346 A1 also describes the use of HTC lignins in rubber compounds for pneumatic tire components, in particular together with a methylene donor compound such as, e.g., hexa(methoxymethyl)melamine, in order to increase the stiffness of a cured rubber component of a pneumatic tire and, among other things, to replace phenolic resins. WO 2017/194346 A1 also mentions a possible in-situ modification using organosilanes as coupling reagents. However, the same disadvantages mentioned hereinabove that the in-situ modification entails in connection with WO 2017/085278 A1 are associated with this.

Therefore, there is a need for new organic fillers that are suitable for incorporation into rubber compositions, and for such rubber compositions per se, which do not exhibit the above disadvantages.

### Object

It is therefore an object of the present invention to provide environmentally friendly fillers which are directly suitable as such for incorporation into rubber compositions, in particular to provide tire components such as tire treads and tire components for the tire substructure (carcass) and/or to provide components for technical rubber articles, in particular with regard to an improvement in the aging resistance and long-term stability of the rubber compositions, also in vulcanized form, an increased resistance to media and hydrolysis resistance compared with the fillers of the prior art, improved mechanical properties such as moduli, tensile strength and elongation at break, and to enable advantages in the processing of components when they are dynamically deformed (hysteresis advantages), especially in the field of technical rubber articles. At the same time, these fillers should be universally applicable and, in particular, allow at least partial replacement of silanized silica as a filler in rubber compositions in an economical and simple manner, without having to make the reaction process for producing these compositions more complex, and still make it possible to obtain rubber compositions with at least equally good properties. Furthermore, it is an object of the present invention to provide corresponding rubber compositions as such which contain these fillers.

### Solution

This object is achieved by the subject matters claimed in the patent claims as well as the preferred embodiments of these subject matters as described in the following specification.

A first subject matter of the present invention is therefore an organic filler with a ¹⁴C content in a range from 0.20 to 0.45 Bq/g carbon,
characterized in that a covalent bonding of at least one organic modifier to the organic filler has been effected at least via a part of the oxygen atoms of at least one functional group of the filler which is selected from phenolic OH groups, phenolate groups, aliphatic OH groups, carboxylic acid groups, carboxylate groups and mixtures thereof, wherein the bonding has not taken place in the presence of a rubber,
wherein the at least one organic modifier employed is an organosilane that has at least one organic radical and at least one hydrolyzable functional group X that is reactive with the at least one functional group of the filler by means of which the bonding to the filler has taken place,
and wherein the organic filler preferably has a BET surface area in a range from 10 to <200 m²/g.

The covalent bonding of at least one organic modifier to the organic filler has not taken place in the presence of a rubber. This means in particular that the bonding of the at least one organic organosilane modifier to the filler employed for this purpose (i.e., the filler FPM prior to modification, which is described hereinbelow) does not take place in situ within a rubber composition, but the bonding already takes place in a separate prior step (“ex situ”). In other words, no rubber is present during the modification using the at least one modifier employed according to the invention. Preferably, the organic filler according to the invention is present in rubber-free form.

Another subject matter of the present invention is a rubber composition, comprising at least one rubber component that contains at least one rubber, and a filler component, wherein the filler component contains at least one organic filler according to the invention as described in connection with the first subject matter of the present invention.

Another subject matter of the present invention is a vulcanizable rubber composition comprising the rubber composition according to the invention and a vulcanization system, preferably comprising at least zinc oxide and/or at least sulfur and/or at least one preferably organic peroxide, particularly preferably comprising at least sulfur.

Another subject matter of the present invention is a kit of parts, comprising, in spatially separated form, a rubber composition according to the invention as part (A) and a vulcanization system, as contained in the vulcanizable rubber composition according to the invention, as part (B).

Another subject matter of the present invention is a vulcanized rubber composition that can be obtained by a vulcanization of the vulcanizable rubber composition according to the invention or by vulcanization of a vulcanizable rubber composition obtainable by combining and mixing the two parts (A) and (B) of the kit of parts according to the invention.

Another subject matter of the present invention is a use of at least one organic filler according to the invention for the production of rubber compositions and vulcanizable rubber compositions for employment in the production of tires, preferably pneumatic tires and solid tires, in particular pneumatic tires, preferably for the tread, sidewall and/or inner liner thereof, respectively, and/or for employment in the production of technical rubber articles, preferably to produce profiles, seals, dampers and/or hoses.

It has been found that the organic filler according to the invention is an environmentally friendly alternative both to known fillers, in particular inorganic fillers, and to carbon blacks for rubber applications.

Further, it has been surprisingly found that the organic filler according to the invention is directly suitable as such for incorporation into rubber compositions, in particular to produce treads, sidewalls and/or inner liners of tires, such as of pneumatic tires and solid tires, and/or to produce technical rubber articles such as profiles, seals, dampers and/or hoses.

In addition, it has been surprisingly found that the organic filler according to the invention exhibited good compatibility with the rubbers present in rubber compositions. It has been found in particular, that by the covalent bonding of the at least one organic organosilane modifier to the organic filler at least via a part of the oxygen atoms of at least one functional group of the filler which is selected from phenolic OH groups, phenolate groups, aliphatic OH groups, carboxylic acid groups, carboxylate groups and mixtures thereof, i.e., by the effected surface modification of the filler, a decrease in the polarity of the filler can be achieved to such an extent that the compatibility with comparatively non-polar rubbers is improved. In particular, it has been shown that the compatibility can be further improved if the at least one organic modifier employed has at least one other functional group FGK that is different from the at least one reactive functional group X, and that—when the filler is employed together with at least one rubber within a rubber composition—shows reactivity with the at least one rubber and/or with at least one functional group of this rubber and/or with the vulcanization system used, in particular during vulcanization. In this case, the bonding of the filler to the rubber and/or the vulcanization system, too, is possible as late as during vulcanization, and thus in particular the reinforcing properties (such as moduli, elongation at break, hysteresis, tear propagation resistance and/or tensile strength) of the vulcanized composition, in addition to improved compatibility, are improved even further.

Furthermore, it has been surprisingly found that the organic filler according to the invention allows an improvement of the aging resistance and long-term stability of the rubber compositions even in vulcanized form. Surprisingly, it has been shown that the organic filler according to the invention exhibits in particular an increased resistance to media, especially to bases, and hydrolysis resistance compared to the fillers of the prior art. In particular, it has been found that the covalent bonding of the at least one organic organosilane modifier to the filler, i.e., the surface modification of the filler, not only improved the aforementioned compatibility, but also the proportion of free phenolic OH groups, phenolate groups, aliphatic OH groups, carboxylic acid groups, carboxylate groups and mixtures thereof could be reduced to such an extent that undesirable reactions potentially occurring with these groups, which adversely affect the aging resistance and long-term stability, could be prevented or at least reduced. In this context, it has been found in particular that the susceptibility of the filler according to the invention to hydrolysis could at least be reduced as a result of the surface modification carried out and that the resistance to media, in particular to bases, could be increased. The reinforcing properties of the vulcanized composition are also improved further thereby.

Furthermore, it has been surprisingly found that the bonding of the at least one organosilane modifier to the filler employed (that is, the filler FPM described hereinbelow) can be effected in a separate prior step (“ex situ”) and thus an in-situ bonding does not necessarily have to occur within the rubber composition in the presence of a rubber. This has the advantage, in particular, that the organic filler according to the invention that has already been modified can be used specifically as such in rubber compositions as a filler, especially also in combination with other fillers such as inorganic fillers, in particular with (unmodified) silica, and this in particular when a modification of the other fillers such as silica with suitable modifiers such as organosilanes within the rubber compositions is envisaged and therefore still has to be carried out in situ. The “ex-situ” modification thus allows the user the employment of the modified reinforcing filler according to the invention without the need to consider chemical reactions in the mixing process. This facilitates the control of the mixing process and the focus on the mechanical mixing of the constituents.

In particular, it has been surprisingly found that the organic filler according to the invention is universally applicable and, in particular, allows partial replacement of silanized silicic acid as filler in rubber compositions in an economic and simple manner, without having to make the reaction process for producing these compositions more complex, and still makes it possible to obtain rubber compositions with properties that are at least as good. The “ex-situ” modification avoids the problem that the silanization of the organic filler and the silicic acid does not or cannot take place simultaneously, but under different reaction conditions, since in particular the reaction kinetics of the silane bonding are very different in each case. Because the filler according to the invention can be used in an already silanized form, the reaction conditions in the above case can therefore be tailored to the silanization of the silicic acids alone.

Further, it has been surprisingly found that corresponding rubber compositions, in particular vulcanizable rubber compositions, that contain the organic filler according to the invention can be used for the production of tires such as pneumatic tires and solid tires, in particular pneumatic tires, preferably for the tread, sidewalls and/or inner liners thereof, respectively, and meet the requirements necessary for this purpose to a very high degree, especially with regard to rolling resistance, abrasion and wet slippage, and a good balance of these requirements. Similarly, it has been surprisingly found that corresponding rubber compositions, in particular vulcanizable rubber compositions, that contain the organic filler according to the invention are suitable for employment in the production of technical rubber articles (rubber goods), in particular profiles, seals, dampers and/or hoses. In particular, it has been found that the modified organic fillers according to the invention enable advantages in the processing of components when they are dynamically deformed (hysteresis advantages), especially in the field of technical rubber articles.

In particular, it has been surprisingly found that rubber compositions according to the invention, in particular vulcanizable rubber compositions, that contain the organic filler according to the invention, result in vulcanized rubber compositions characterized by increased moduli in the range of up to 200% of elongation, preferably in a range of increase of up to 200%. This has also been found, in particular, when no industrial carbon blacks were used as additional fillers.

It has been found, particularly surprisingly, that rubber compositions according to the invention, in particular vulcanizable rubber compositions, that contain the organic filler according to the invention, lead to vulcanized rubber compositions for employment as tire treads in the passenger car and in particular in the truck sector which, compared with vulcanized rubber compositions comprising silanized precipitated silicic acid instead of the organic filler according to the invention, lead to an improvement in rolling resistance and wet grip with at the same time at least acceptable tire abrasion.

### DETAILED DESCRIPTION

The term “comprising” as used in the present invention in connection with, for example, the rubber compositions according to the invention, the vulcanizable rubber compositions according to the invention and the process steps or stages in the context of processes described herein preferably has the meaning “consisting of”. In this context, for example, with regard to the rubber compositions according to the invention and the vulcanizable rubber composition according to the invention, one or more of the further constituents optionally contained as described hereinbelow may also be contained therein—in addition to the constituents mandatorily present therein. All the constituents may be present in each of their preferred embodiments mentioned below. With regard to the processes according to the invention and described herein, these may have further optional process steps and stages in addition to the mandatory steps and/or stages.

The amounts of all the constituents contained in the compositions described herein, such as the rubber compositions according to the invention and the vulcanizable rubber compositions according to the invention (comprising in each case all the mandatory constituents and, moreover, all the optional constituents), add up in total to 100% by weight, respectively.

### Modified Organic Filler According to the Invention and Organosilane Modifiers Employed According to the Invention

The organic filler according to the invention is an organic filler with a ¹⁴C content in a range from 0.20 to 0.45 Bq/g carbon, wherein a covalent bonding of at least one organic organosilane modifier to the organic filler has been effected at least via a part of the oxygen atoms of at least one functional group of the filler which is selected from phenolic OH groups, phenolate groups, aliphatic OH groups, carboxylic acid groups, carboxylate groups and mixtures thereof. The expression “at least via a part” here means partial or complete, preferably partial. The phenolic OH groups, phenolate groups, aliphatic OH groups, carboxylic acid groups, carboxylate groups and mixtures thereof are preferably localized on the surface of the filler (so called surface-available groups). The determination of the acidic hydroxyl groups available on the surface can be carried out qualitatively and quantitatively colorimetrically according to Sipponen. The method according to Sipponen is based on the adsorption of the alkaline dye Azure B onto the acidic hydroxyl groups accessible on the filler surface. If there is a corresponding adsorption under the conditions cited under item 2.9 (p. 82) of the article mentioned below, acidic, surface-available hydroxyl groups in the sense of the present invention are present. Further details can be taken from the article “Determination of surface-accessible acidic hydroxyls and surface area of lignin by cation dye adsorption” (Bioresource Technology 169 (2014) 80-87). In a quantitative determination, the amount of surface-available acidic hydroxyl groups is given in mmol/g of the filler. Preferably, the amount of surface-available acidic hydroxyl groups is in the range from 0.05 mmol/g to 40 mmol/g, particularly preferably 0.1 mmol/g to 30 mmol/g, and most particularly preferably 0.15 to 30 mmol/g.

Since the filler according to the invention is of organic nature, inorganic fillers such as precipitated silicic acids do not fall under this category.

The terms filler and organic filler in particular are known to the person skilled in the art. Preferably, the organic filler employed according to the invention is a reinforcing filler, i.e., an active filler. Reinforcing or active fillers, in contrast to inactive (non-reinforcing) fillers, can change the viscoelastic properties of a rubber by interacting with the rubber within a rubber composition. For example, they can influence the viscosity of the rubbers and can improve the fracture behavior of the vulcanizates, for example with regard to tear strength, tear propagation resistance and abrasion. Inactive fillers, on the other hand, dilute the rubber matrix.

The organic filler according to the invention has a ¹⁴C content in a range from 0.20 to 0.45 Bq/g carbon, preferably 0.23 to 0.42 Bg/g carbon. The required ¹⁴C content cited above is achieved by organic fillers obtained from biomass, by further treatment or reaction of the same, preferably by fractioning, wherein the fractioning can be carried out thermally, chemically and/or biologically, and preferably is carried out thermally and chemically. Thus, fillers obtained from fossil materials, such as fossil fuels in particular, do not fall under the definition according to the present invention of the fillers to be used according to the invention, since they do not possess a corresponding ¹⁴C content.

Herein, biomass is in principle defined as any biomass, wherein the term “biomass” herein includes so-called phytomass, i.e., biomass originating from plants, zoomass, i.e., biomass originating from animals, and microbial biomass, i.e., biomass originating from microorganisms including fungi, the biomass is dry biomass or fresh biomass, and it originates from dead or living organisms. The biomass particularly preferred herein for the production of the fillers is phytomass, preferably dead phytomass. Dead phytomass comprises, among other things, dead, rejected or detached plants and their parts. These include, for example, broken and torn leaves, cereal stalks, side shoots, twigs and branches, the fallen leaves, felled or pruned trees, as well as seeds and fruits and parts derived therefrom, but also sawdust, wood shavings/chips and other products derived from wood processing.

Preferably, the organic filler according to the invention has a carbon content in a range from 60% by weight to 85% by weight, particularly preferably from 63% by weight to 80% by weight, more particularly preferably from 65% by weight to 75% by weight, in particular from 68% by weight to 73% by weight, relative to the ash-free and water-free filler, respectively. One method for the determination of the carbon content is cited in the Methods section below. In this respect, the organic filler differs both from carbon blacks made of fossil raw materials, as well as from carbon blacks made of regrowing raw materials, since carbon blacks have a corresponding carbon content of at least 95% by weight.

Preferably, the fillers according to the invention have an oxygen content in the range from 15% by weight to 30% by weight, preferably 17% by weight to 28% by weight and particularly preferably 20% by weight to 25% by weight, relative to the ash-free and water-free filler. The oxygen content can be determined by high-temperature pyrolysis, for example using the EuroEA3000 CHNS-O Analyzer of the company EuroVector S.p.A.

The organic filler according to the invention preferably has a BET surface area (specific total surface area according to Brunauer, Emmett and Teller) in a range from 10 to <200 m²/g. A method for the determination of this parameter is cited in the Methods section below. Particularly preferably, the organic filler according to the invention has a BET surface area in a range from 10 to 150 m²/g, more particularly preferably a BET surface area in a range from 20 to 120 m²/g, even more preferably a BET surface area in a range from 30 to 110 m²/g, in particular a BET surface area in a range from 40 to 100 m²/g, most preferably a BET surface area in a range from 40 to <100 m²/g.

The organic filler according to the invention preferably has an STSA surface area in a range from 10 to <200 m²/g. A method for the determination of the STSA surface area (Statistical Thickness Surface Area) is cited in the Methods section below. Preferably, the organic filler according to the invention has an STSA surface area in a range from to 150 m²/g, in particular in a range from 20 to 120 m²/g, particularly preferably in a range from 30 to 110 m²/g, in particular in a range from 40 to 100 m²/g, most preferably in a range from 40 to <100 m²/g.

Preferably, the organic filler according to the invention is a lignin-based organic filler produced from biomass and/or biomass components. For example, the lignin for the production of the lignin-based organic filler may be isolated and extracted from biomass and/or dissolved before its modification according to the invention. Suitable methods for obtaining the lignin for the production of the lignin-based organic filler from biomass are, for example, hydrolytic methods or pulping methods, such as the Kraft pulping method. The term “lignin-based”, as used in the present invention preferably means that one or more lignin units and/or one or more lignin scaffolds are present in the organic filler according to the invention. Lignins are solid biopolymers that are incorporated into plant cell walls and thus effect the lignification of plant cells. As such, they are present in biomass and in particular in biologically regrowing raw materials, and they therefore represent—in particular in hydrothermally treated form—an environmentally friendly filler alternative.

Preferably, the lignin, and preferably the organic filler according to the invention as such, if it is a lignin-based filler, is present at least partially in hydrothermally treated form, and is particularly preferably obtainable by means of hydrothermal treatment, respectively. Particularly preferably, the organic filler according to the invention is based on lignin that can be obtained by hydrothermal treatment. Suitable methods of the hydrothermal treatment, in particular of lignins and lignin-containing organic fillers, are described in WO 2017/085278 A1 and WO 2017/194346 A1 as well as in EP 3 470 457 A1, for example. The hydrothermal treatment is preferably carried out at a temperature in a range between 150° C. and 250° C. in the presence of liquid water.

Preferably, the organic filler according to the invention has a pH in a range from 7 to 9, particularly preferably in a range from >7 to <9, most preferably in a range from >7.5 to <8.5.

The at least one organic modifier employed for the covalent bonding is an organosilane that has, prior to the bonding, at least one hydrolyzable functional group X that is reactive with the at least one functional group of the filler by means of which the bonding to the filler takes place. One or more organosilanes can be used that are different from one another.

The covalent and thus chemical bonding of the at least one organic modifier to organic filler employed for this purpose, preferably to the lignin contained in the filler, is effected by chemical reaction via a part of the oxygen atoms of the at least one functional group of the filler that is selected from phenolic OH groups, phenolate groups, aliphatic OH groups, carboxylic acid groups, carboxylate groups and mixtures thereof, in each case with at least one functional group X of the organic modifier that is reactive to these groups and hydrolyzable. By the at least partial reaction the polarity of the filler is advantageously changed. Depending on the type of modifier used or the organic radical it contains, a physical shielding effect can also occur (e.g., in the case of organosilanes with comparatively long-chain hydrophobic radicals such as C₈ alkyl groups or >C₈ alkyl groups).

If a covalent bonding of the at least one organic modifier to the organic filler is effected only via a part of the oxygen atoms of the phenolic OH groups, phenolate groups, aliphatic OH groups, carboxylic acid groups, carboxylate groups and mixtures thereof, the organic filler according to the invention can after the bonding still present free phenolic OH groups, phenolate groups, aliphatic OH groups, carboxylic acid groups, carboxylate groups and mixtures thereof. Preferably, this is the case.

If a covalent bonding of the at least one organic modifier to the organic filler is effected via all of the oxygen atoms of the phenolic OH groups, phenolate groups, aliphatic OH groups, carboxylic acid groups, carboxylate groups and mixtures thereof, the organic filler according to the invention has no more free phenolic OH groups, phenolate groups, aliphatic OH groups, carboxylic acid groups, carboxylate groups and mixtures thereof. Of course, mixed forms are also possible: for example, the filler may still have one or more types of its functional group after bonding, for example aliphatic OH groups, carboxylic acid groups, carboxylate groups and mixtures thereof, whereas all phenolic OH groups and phenolate groups previously present have been reacted.

Preferably, the organic filler according to the invention is present in rubber-free form.

For the production of the organic filler according to the invention, an organic filler FPM with a ¹⁴C content in the range from 0.20 to 0.45 Bq/g carbon is suitable as the starting material or precursor, which contains at least one functional group selected from phenolic OH groups, phenolate groups, aliphatic OH groups, carboxylic acid groups, carboxylate groups and mixtures thereof. A covalent bonding of the at least one organic modifier employed according to the invention has not yet occurred at this time. At least in this respect, the filler FPM used according to the invention differs from the organic filler according to the invention.

Preferably, the organic filler according to the invention is obtainable by carrying out at least one step a) and optionally one or more of steps b) to d), viz.
a) bringing together the at least one modifier employed according to the invention and at least one organic filler FPM which has a ¹⁴C content in a range from 0.20 to 0.45 Bq/g carbon and which has at least one functional group that is selected from phenolic OH groups, phenolate groups, aliphatic OH groups, carboxylic acid groups, carboxylate groups and mixtures thereof,
b) optionally heating the mixture obtained according to step a), which is preferably present within a liquid or gaseous reaction medium, preferably to a temperature in a range from 30° C. to 190° C., particularly preferably to a temperature in a range from 50° C. to 180° C., more particularly preferably to a temperature in a range from 70° C. to 170° C.,
c) after the covalent bonding of the modifier to the filler FPM optionally extracting at least one organic solvent, if the bringing together according to step a) and the optional heating according to step b) was performed in a liquid reaction medium that contains at least one organic solvent, and
d) after the covalent bonding of the modifier to the filler FPM, optionally drying the product obtained after performing step a) and optionally step b) and/or c), preferably under vacuum and/or at a temperature in a range from 20 to 100° C.

The bringing together according to step a) and optionally also the heating according to optional step b) can be carried out in a reaction medium which is preferably liquid or gaseous. The modifier used and/or the filler FPM and/or the resulting mixture may each optionally be present in a liquid or gaseous reaction medium. The liquid reaction medium may preferably contain or consist of at least one organic solvent, particularly preferably at least one hydrocarbon, most preferably at least one aliphatic and/or aromatic hydrocarbon. In the case of a gaseous reaction medium, the covalent bonding of the modifier to the filler FPM can be achieved by CVD (chemical vapor deposition).

Preferably, the bringing together according to step a) is carried out at room temperature (18 to <30° C.). The covalent bonding of the modifier to the filler FPM can already take place under these conditions. Optionally and preferably, however, step b) is performed. In this case, the covalent bonding of the modifier to the filler FPM preferably takes place at the temperature ranges mentioned hereinabove in connection with step b).

The extraction according to optional step c) is preferably carried out at a temperature in a range from 20 to 150° C. and may optionally be carried out under vacuum.

Preferably, after and/or during the performance of step a) and optional step b), the reaction mixture is mixed for a period of from 0.01 to 30 h, particularly preferably from 0.01 to 5 h, for example by stirring, in particular to achieve complete reaction with the modifier employed in the amount used.

Preferably, the organic filler according to the invention contains, relative to its total weight, after covalent bonding has taken place, the organic modifier in a proportion in a range from 0.1 to 30% by weight, particularly preferably from 0.5 to 25% by weight, most preferably from 1.0 to 15% by weight, particularly from 1.5 to 12% by weight. Of course, it must be taken into account here that the reaction of the hydrolyzable functional groups X with the corresponding groups of the organic filler can form cleavage products such as alcohols, which thus do not contribute to the amount of modifier in the filler.

The at least one organic modifier employed for the covalent bonding that is at least one organosilane contains at least one organic radical, and prior to the bonding, at least one hydrolyzable functional group X that is reactive with the at least one functional group of the filler by means of which the bonding to the filler takes place.

Preferred “hydrolyzable groups” in the sense of the present invention are alkoxy groups, in particular C₁-C₄ alkoxy groups, and/or halide groups, preferably fluoride, chloride, bromide and/or iodide groups, even more preferably fluoride and/or chloride groups, most preferably chloride groups.

Preferably, the at least one organic modifier is at least one monosilane, which preferably has at least two, particularly preferably three hydrolyzable groups X, and/or is at least one bis(silane), which preferably has at least four, particularly preferably six hydrolyzable groups X. The hydrolyzable groups X may each be the same or at least two of these groups may be different from each other, respectively. Preferably, the hydrolyzable groups X are alkoxy groups, in particular C₁-C₄ alkoxy groups, and/or halide groups, in particular fluoride, chloride, bromide and/or iodide groups. Methoxy, ethoxy, n-propoxy, iso-propoxy, n-butoxy, see-butoxy and tert-butoxy groups are particularly preferred. Ethoxy groups and methoxy groups are most preferred.

Preferably, the at least one organic modifier employed has at least one other functional group FGK that is different from the at least one reactive functional group X, and which is preferably part of the at least one organic radical of the modifier, and that—when the filler according to the invention is employed together with at least one rubber within a rubber composition—shows reactivity with the at least one rubber and/or with at least one functional group of this rubber and/or a vulcanization system present in the rubber composition, in particular during a vulcanization, wherein the at least one other functional group FGK is preferably selected from the group consisting of carbon-carbon double bonds, in particular vinyl groups, and sulfur-containing groups and mixtures thereof, particularly preferably is selected from the group consisting of carbon-carbon double bonds in cis position, mercapto groups, which may optionally be blocked, and di- and/or polysulfide groups, as well as mixtures thereof.

Preferably, the at least one organic modifier used has at least one other functional group FGB that is different from the at least one reactive functional group X, and that preferably is also different from the other functional group FGK optionally present, and which is preferably part of the at least one organic radical of the modifier. Preferably, the at least one other functional group FGB is a functional group which increases the basicity of the filler after bonding of the organic modifier, particularly preferably an amino group, in particular an amino group selected from the group consisting of primary and secondary amino groups. In addition, it is also possible that a further chemical bond to the filler occurs via the at least one other functional group FGB of the organic modifier, in particular if this is an amino group.

The at least one organic radical of the organosilane(s) used is preferably a non-hydrolyzable organic radical. Preferably, the radical is selected from the group comprising C₁-C₂₀ aliphatic radicals, C₁-C₂₀ heteroaliphatic radicals, C₃-C₂₀ cycloaliphatic radicals, 3-20 membered heterocycloaliphatic radicals, 5-20 membered aryl or heteroaryl radicals, C₃-C₂₀-cycloaliphatic radical bonded via a C₁₋₁₀-aliphatic radical, 3-20-membered heterocycloaliphatic radicals bonded via a C₁₋₁₀-aliphatic radical, 5-20-membered aryl or heteroaryl radicals bonded via a C₁₋₁₀-aliphatic radical, wherein each of these radicals may optionally contain at least one reactive functional group, in particular at least one functional group FGK and/or at least one functional group FGB.

Preferably, the at least one organic modifier is at least one organosilane of the general formula (I) and/or (II)

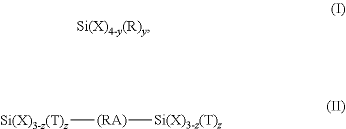

wherein, in the case of the general formula (I),
X respectively and independently from one another represents a hydrolyzable functional group that is reactive with phenolic OH groups, phenolate groups, aliphatic OH groups, carboxylic acid groups, carboxylate groups and/or mixtures thereof, and that respectively and independently from one another is selected from O—C₁₋₄ alkyl and halides,
the parameter y represents an integer in the range from 1 to 3, however is at least 1, and preferably is exactly 1, and
R represents a non-hydrolyzable organic radical, preferably a C₃-C₂₀ aliphatic radical, optionally containing at least one reactive functional group FGK and/or at least one functional group FGB, and
wherein, in the case of the general formula (II),
X respectively and independently from one another represents a hydrolyzable functional group that is reactive with phenolic OH groups, phenolate groups, aliphatic OH groups, carboxylic acid groups, carboxylate groups and/or mixtures thereof, and that respectively and independently from one another is selected from O—C₁₋₄ alkyl and halides,
RA represents a non-hydrolyzable organic radical with two bonds, preferably a C₆-C₂₀ aliphatic radical with two bonds, optionally containing at least one reactive functional group FGK and/or at least one functional group FGB,
the parameter z respectively represents an integer in the range from 0 to 3, preferably means 0 in each case, and
T represents a non-hydrolyzable organic radical that is different from the radical (RA) and preferably has no functional groups FGB and FGK, and particularly preferably is an aliphatic C₁-C₂₀ radical.

Preferably, the at least one organic modifier is at least one organosilane of general formula (II).

In the case of monosilanes of general formula (I), it is preferred if the radical R has at least one thiol group as functional group FGK and/or if the radical is at least one C₈ aliphatic radical optionally having at least one functional group FGK. Examples of monosilanes that can be used u according to the invention are 3-mercaptopropyltriethoxysilane (Si263) and octyltriethoxysilane. Examples of monosilanes that can be used according to the invention are furthermore 3-chloropropyl-trichlorosilanes, wherein the following nucleophiles can also be used instead of chlorine on the propyl group, which improve the physical interaction with the polymer or react chemically with the polymer used:
alkyls
alkylenes
monosulfide
disulfide
thiocyanate
thiourea
methacrylate
trimethylamine
trialkylamine
N,N-dimethyloctadecylamine
azide
isocyanate
diphenylphosphide
cyanide
cyclopentadiene
epoxy
epoxycyclohexyl
amine.

In the case of bis(silanes) of the general formula (I), it is preferred if the radical RA has at least one disulfide or polysulfide group and/or at least one carbon double bond, preferably in cis position, as the functional group FGK. Examples of bis(silanes) that can be used according to the invention are TESTP (Si69; (bis-[triethoxysilylpropyl]tetrasulfide) and TESPD (in particular Si75 and Si266) (bis-[triethoxysilylpropyl]disulfide). Examples of bis(silanes) as halosilanes which can be used according to the invention are furthermore (bis-[trichlorosilylpropyl]tetrasulfide), (bis-[trichlorosilylpropyl]disulfide) and/or (bis-[trichlorosilylpropyl]amine).

Preferably, the organic filler according to the invention exhibits only conditional solubility in alkaline media, in particular in 0.1 M or 0.2 M NaOH. The solubility is determined according to the method described hereinbelow. Preferably, the solubility of the organic filler is lower than 30%, particularly preferably lower than 25%, more particularly preferably lower than 20%, even more preferably lower than 15%, even more preferably lower than 10%, further preferably lower than 7.5%, even more preferably lower than 5%, still more preferably lower than 2.5%, in particular preferably lower than 1%.

### Rubber Composition According to the Invention

Another subject matter of the present invention is a rubber composition, comprising at least one rubber component that contains at least one rubber, and a filler component, wherein the filler component contains at least one organic filler according to the invention as described in connection with the first subject matter of the present invention.

Preferably, the filler component contains at least one organic filler according to the invention as described in connection with the first subject matter of the present invention.

Preferably, the rubber composition comprises the at least one organic filler according to the invention in an amount ranging from 10 to 150, particularly preferably from 15 to 130, more particularly preferably from 20 to 120, in particular from 40 to 100 phr

### Rubber Component of the Rubber Composition

The rubber composition according to the invention comprises at least one rubber component comprising at least one rubber.

Any type of rubber is suitable for the production of the rubber compounds according to the invention. Natural rubber (NR) and synthetic rubbers are familiar to the person skilled in the art. Preferably, the at least one rubber is selected from the group consisting of natural rubber (NR), halobutyl rubbers, in turn preferably selected from the group consisting of chlorobutyl rubbers (CIIR; chloro-isobutene-isoprene rubber) and bromobutyl rubbers (BIIR; bromo-isobutene-isoprene rubber), butyl rubber or isobutylene-isoprene-rubber (IIR; also isobutene-isoprene rubber), styrene-butadiene rubber (SBR), in turn preferably SSBR (solution polymerized SBR) and/or ESBR (emulsion polymerized SBR), polybutadiene (BR, butadiene rubber), acrylonitrile-butadiene rubbers (NBR, nitrile rubber) and/or HNBR (hydrated NBR), chloroprene (CR), polyisoprene (IR), ethylene-propylene-diene rubber (EPDM), and mixtures thereof.

Particularly preferably, the at least one rubber is selected from the group consisting of styrene-butadiene rubber (SBR), again preferably SSBR, polybutadiene (BR, butadiene rubber), EPDM, NR and acrylonitrile-butadiene rubbers (NBR, nitrile rubber), and mixtures thereof. Particularly preferred are styrene-butadiene rubber (SBR), again preferably SSBR and polybutadiene (BR, butadiene rubber) and mixtures thereof.

In the case of mixtures of SBR and BR, the proportion of SBR is preferably higher than the proportion of BR.

The total amount of SBR rubber is preferably 60 to 100 phr, preferably 65 to 100 phr, particularly preferably 70 to 100 phr. The total amount of BR rubber is preferably 0 to phr, preferably 0 to 35 phr, particularly preferably 0 to 30 phr.

The phr (parts per hundred parts of rubber by weight) specification used herein is the quantity specification commonly used in the rubber industry for compound formulations. The dosage of the parts by weight of the individual constituents is always relative to 100 parts by weight of the total mass of all rubbers present in the compound.

### Filler Component of the Rubber Composition

The rubber composition according to the invention comprises at least one filler component, wherein the filler component contains at least one organic filler according to the invention.

The rubber composition according to the invention preferably contains 10 to 150, particularly preferably 15 to 130, more particularly preferably 20 to 120, in particular 40 to 100 phr of the organic filler according to the invention as defined hereinabove.

Apart from these aforementioned fillers, the rubber compositions may contain other fillers different from these fillers.

In the case that the organic filler according to the invention serves only as a partial replacement of common industrial carbon blacks, the rubber compositions according to the invention may also contain industrial carbon blacks, in particular furnace carbon blacks, as classified as general-purpose carbon blacks under ASTM Code N660, for example.

In addition, or as an alternative, the rubber compositions according to the invention can in particular contain inorganic fillers, for example those having a different particle size, particle surface and chemical nature with different potential to influence the vulcanization behavior. In the event that further fillers are included, these should preferably have properties as similar as possible to the organic fillers according to the invention employed in the rubber composition according to the invention, especially with regard to their pH values.

If other fillers are employed, they are preferably phyllosilicates such as clay minerals, for example talc; carbonates such as calcium carbonate; silicates such as for example calcium, magnesium and aluminum silicates; and oxides such as for example magnesium oxide and silica or silicic acid.

In particular in the case that the organic filler according to the invention serves only as a partial replacement for common silicic acids or silica, the rubber compositions according to the invention may also contain such inorganic fillers such as silica or silicic acid. These inorganic fillers can then be subjected to in-situ modification.

However, in the context of the present invention, zinc oxide does not fall under the inorganic fillers, since zinc oxide herein has the function of a vulcanizer or an additive promoting vulcanization. Additional fillers must be chosen with care, however, since higher amounts of magnesium oxide, for example, can negatively affect the adhesion to adjacent tire layers, and silica tends to bond organic molecules, such as the thiazoles used in some vulcanization systems, to its surface and thus inhibit their action.

Inorganic fillers, among them preferably silica and other fillers, which carry Si—OH groups on their surface, may also be surface-treated (surface-modified). In particular, a silanization with organosilanes, such as for example alkylalkoxysilanes or aminoalkylalkoxysilanes or mercaptoalkylalkoxysilanes, may be of advantage. The alkoxysilane groups can, for example, bond to the surfaces of silicates or silica, or to other suitable groups, by hydrolytic condensation, while the amino groups and thiol groups, for example, can react with isoprene units of certain rubbers. This can cause a mechanical reinforcement of the vulcanized rubber compositions of the present invention.

The fillers different from the organic fillers according to the invention can be used individually or in combination with each other.

In the event that other fillers are used, their proportion is preferably less than 40 phr, particularly preferably 20 to 40 phr and particularly preferably 25 to 35 phr.

### Other Constituents of the Rubber Composition

The rubber composition according to the invention may contain further optional constituents such as softening agents and/or antidegradants, resins, in particular adhesion-enhancing resins, and even already vulcanizers and/or vulcanization-promoting additives, such as zinc oxide and/or fatty acids such as stearic acid.

With the use of softening agents, it is possible to influence properties of the unvulcanized rubber composition, such as processability, in particular, but also properties of the vulcanized rubber composition, such as its flexibility, especially at low temperatures. Particularly suitable softening agents in the context of the present invention are mineral oils from the group of paraffinic oils (substantially saturated chain-shaped hydrocarbons) and naphthenic oils (substantially saturated ring-shaped hydrocarbons). It is also possible, and even preferred, to employ aromatic hydrocarbon oils. However, with regard to the adhesion of the rubber composition to other rubber-containing components in tires, such as for example the carcass, a mixture of paraffinic and/or naphthenic oils could also be advantageous as softening agent. Other possible softening agents are for example esters of aliphatic dicarboxylic acids, such as for example adipic acid or sebacic acid, paraffin waxes and polyethylene waxes. Among the softening agents, paraffinic oils and naphthenic oils are particularly suitable in the context of the present invention; most preferred are however aromatic oils, in particular aromatic mineral oils.

Preferably, softening agents, and among them particularly preferred the paraffinic and/or naphthenic, and in particular aromatic process oils, are employed in a quantity of 0 to 100 phr, preferably 10 to 70 phr, particularly preferably 20 to 60 phr, in particular to 50 phr.

Examples of antidegradants are quinolines such as TMQ (2,2,4-trimethyl-1,2-dihydroquinoline) and diamines such as 6-PPD (N-(1,3-dimethylbutyl)-N′-phenyl-p-phenylenediamine).

So-called adhesion-enhancing resins can be used to improve the adhesion of the vulcanized rubber compound of the present invention to other adjacent tire components. Particularly suitable resins are those based on phenol, preferably from the group consisting of phenolic resins, phenol-formaldehyde resins and phenol-acetylene resins. In addition to the phenolic-based resins, aliphatic hydrocarbon resins such as Escorez™ 1102 RM from the company ExxonMobil, as well as aromatic hydrocarbon resins, may also be used. Aliphatic hydrocarbon resins particularly improve the adhesion to other rubber components of the tire. They generally have lower adhesion than the resins based on phenol and can be used either alone or as a mixture with the resins based on phenol.

If the adhesion-enhancing resins are used at all, then preferably those selected from the group consisting of resins based on phenol, aromatic hydrocarbon resins and aliphatic hydrocarbon resins. Preferably, their proportion is 0 to 15 phr or 1 to 15 phr, particularly preferably 2 to 10 phr, and more particularly preferably 3 to 8 phr.

The rubber composition according to the invention may also contain additives that promote vulcanization, but are unable to start it on their own. Such additives include, for example, vulcanization accelerators such as saturated fatty acids with 12 to 24, preferably 14 to 20, and particularly preferably 16 to 18 carbon atoms, such as stearic acid, and the zinc salts of the aforementioned fatty acids. Thiazoles may also belong to these additives. However, it is also possible to use vulcanization-promoting additives only in the vulcanization systems described hereinbelow.

If vulcanization-promoting additives and in particular the above-mentioned fatty acids and/or their zinc salts, preferably stearic acid and/or zinc stearate, are used in the rubber compositions according to the invention, their proportion is preferably 0 to 10 phr, particularly preferably 1 to 8 phr and particularly preferably 2 to 6 phr.

Moreover, the rubber composition according to the invention may also already contain certain vulcanizers such as zinc oxide, which is preferred. However, it is also possible to use such vulcanizers only in the vulcanization systems described hereinbelow.

If vulcanizers such as zinc oxide are used in the rubber compositions according to the invention, their proportion is preferably 0 to 10 phr, particularly preferably 1 to 8 phr and particularly preferably 2 to 6 phr.

### Vulcanizable Rubber Composition According to the Invention

Another subject matter of the present invention is a vulcanizable rubber composition comprising the rubber composition according to the invention as component (A) and a vulcanization system as component (B), preferably a vulcanization system comprising at least zinc oxide and/or at least sulfur, particularly preferably comprising at least sulfur.

All preferred embodiments described hereinabove in connection with the modified organic filler according to the invention are also preferred embodiments with regard to the vulcanizable rubber composition according to the invention.

The vulcanization systems are not included herein among the rubber compositions of the invention, but are treated as additional systems that condition their cross-linking. By addition of the vulcanization systems to the rubber compositions according to the invention, the vulcanizable rubber compositions also according to the invention are obtained.

The rubber component of the vulcanizable rubber composition according to the invention that is used according to the invention and which contains at least one rubber, allows the use of a wide variety of different vulcanization systems.

The vulcanization of the rubber compositions of the present invention takes place preferably by using at least zinc oxide and/or at least sulfur and/or at least one peroxide, such as at least one organic peroxide, in particular. If zinc oxide is used, it can be added to the rubber component (A) or to component (B). Preferably, zinc oxide is added to component (A). If sulfur is used, it is preferably added to component (B).

Preferably, at least zinc oxide and/or at least sulfur and/or at least one peroxide is used in combination with different organic compounds for vulcanization. By means of the different additives, the vulcanization behavior as well as the properties of the vulcanized rubbers thus obtained can be influenced.

In a first variant of a vulcanization based at least on zinc oxide, preferably small amounts of a saturated fatty acid with 12 to 24, preferably 14 to 20 and particularly preferably 16 to 18 carbon atoms, for example stearic acid and/or zinc stearate, are added to the zinc oxide as a vulcanization accelerator. This allows to increase the vulcanization rate. Most often, however, the final extent of vulcanization is reduced with the use of the fatty acids mentioned.

In a second variant of a vulcanization based at least on zinc oxide, so-called thiurams, such as thiuram monosulfide and/or thiuram disulfide, and/or tetrabenzylthiuram disulfide (TbzTD) and/or dithiocarbamates and/or sulfenamides are added to the zinc oxide, in the absence of sulfur or alternatively in presence of sulfur, in order to shorten the scorch time and to improve the vulcanization efficiency by forming particularly stable networks. The thiazoles and sulfenamides are preferably selected from the group consisting of 2-mercaptobenzothiazole (MBT), mercaptobenzothiazyl disulfide (MBTS), N-cyclohexyl-2-benzothiazyl sulfenamide (CBS), 2-morpholino-thiobenzothiazole (MBS) and N-tert-butyl-2-benzothiazyl sulfenamide (TBBS).

In a third variant of a vulcanization based at least on zinc oxide, an alkylphenol disulfide is added to the zinc oxide to adapt the scorch times, in particular to accelerate them. Another, fourth variant of a vulcanization based at least on zinc oxide employs a combination of zinc oxide with polymethylolphenol resins and their halogenated derivatives, in which preferably neither sulfur nor sulfur-containing compounds are used.

In a further, fifth variant of a vulcanization based at least on zinc oxide, which is most preferred, the vulcanization is carried out by means of a combination of zinc oxide with thiazoles and/or thiurams and/or sulfenamides, and preferably sulfur. The addition of sulfur to such systems increases both the vulcanization rate and the extent of vulcanization and contributes to the workability of the rubber compositions during the vulcanization process. The use of this vulcanization system preferably provides heat- and fatigue-resistant vulcanized materials that exhibit good adhesion to other components of vehicle tires, especially to rubber compositions of the carcass, even in the vulcanized state. A particularly advantageous vulcanization system comprises zinc oxide, a thiuram such as tetrabenzylthiuram disulfide (TbzTD), a sulfenamide such as N-tert-butyl-2-benzothiazyl sulfenamide (TBBS), and sulfur. Particularly preferred is the combination of the first variant with the fifth variant, i.e., the use of a vulcanization system comprising zinc oxide, a thiuram such as tetrabenzylthiuram disulfide (TbzTD), a sulfenamide such as N-tert-butyl-2-benzothiazyl sulfenamide (TBBS), sulfur, as well as stearic acid and/or optionally zinc stearate.

Less preferred vulcanization systems are based on a pure sulfur vulcanization or a peroxide vulcanization, wherein the latter can lead to an undesirable reduction in molecular weights due to cleavage of the molecules, in particular when butyl rubber or other rubbers are used.

In the context of the present invention, the vulcanization of the rubber composition according to the invention is carried out in the presence of the organic fillers according to the invention, such as HTC lignins.

Components of the vulcanization systems, which as such cannot initiate vulcanization, may also be contained in the rubber composition of the present invention as “other constituents of the rubber composition”, i.e., may already be part of the rubber composition according to the invention and must therefore not necessarily be present in the vulcanization system. Thus, as already mentioned above, it is possible that in particular the stearic acid and/or optionally zinc stearate are already present in the rubber composition according to the invention, and the complete vulcanization system is formed in situ, for example, by mixing/adding at least zinc oxide and at least sulfur.

### Kit of Parts According to the Invention

Due to the connection between the rubber compositions according to the invention and the cross-linking systems (vulcanization systems) to be selected for their vulcanization for the production of a vulcanizable rubber composition according to the invention, the present invention also relates to a kit of parts comprising, in spatially separated form, a rubber composition according to the invention as part (A) and a vulcanization system, preferably a vulcanization system comprising at least zinc oxide and/or at least sulfur, as part (B). In the kit of parts, the rubber composition according to the invention and the vulcanization system are spatially separated from one another and can thus be stored. The kit of parts serves for the production of a vulcanizable rubber composition. For example, the rubber composition according to the invention constituting one part of the kit of parts can be used as part (A) in stage 1 of the process described hereinbelow for producing a vulcanizable rubber compound, and the second part of the kit of parts, i.e., the vulcanization system, can be used as part (B) in stage 2 of said process.

In contrast to the vulcanizable rubber composition that already contains both the constituents of the rubber composition according to the invention and those of the associated vulcanization system homogeneously mixed so that the vulcanizable rubber composition can be vulcanized directly, the rubber composition according to the invention and the vulcanization system are spatially separated from each other in the kit of parts according to the invention.

All systems already described hereinabove in connection with the vulcanizable rubber composition according to the invention can be used as vulcanization system.

All preferred embodiments described hereinabove in connection with the modified organic filler according to the invention and the vulcanizable rubber composition according to the invention are also preferred embodiments with regard to the kit of parts according to the invention.

Preferably, the kit of parts according to the invention comprises, as
part (A) a rubber composition according to the invention, and as
part (B) a vulcanization system comprising at least zinc oxide and/or at least sulfur,
wherein at least zinc oxide can alternatively be present within part (A).

Particularly preferably, the kit of parts according to the invention comprises, as
part (A) a rubber composition according to the invention, and as
part (B) a vulcanization system comprising zinc oxide, sulfur and at least one thiuram, wherein at least zinc oxide can alternatively be present within part (A).

Even more particularly preferably, the kit of parts according to the invention comprises, as
part (A) a rubber composition according to the invention, and as
part (B) a vulcanization system comprising zinc oxide, sulfur, at least one thiuram,
and at least one saturated fatty acid such as stearic acid and/or optionally zinc stearate, wherein at least zinc oxide and/or stearic acid and/or zinc stearate can alternatively be present within part (A).

In particular, the kit of parts according to the invention comprises, as
part (A) a rubber composition according to the invention, and as
part (B) a vulcanization system comprising zinc oxide, sulfur, at least one thiuram,
at least one sulfenamide, and at least one saturated fatty acid such as stearic acid and/or optionally zinc stearate, wherein at least zinc oxide and/or stearic acid and/or zinc stearate can alternatively be present within part (A).

### Process for Producing the Rubber Composition According to the Invention and for Producing the Vulcanizable Rubber Composition According to the Invention

Another subject matter of the present invention is a process for producing the rubber composition according to the invention and a process for producing the vulcanizable rubber composition according to the invention.

All preferred embodiments described hereinabove in connection with the modified organic filler according to the invention, the rubber composition according to the invention, the vulcanizable rubber composition according to the invention and the kit of parts according to the invention are also preferred embodiments with regard to the process according to the invention.

The production of the vulcanizable rubber composition according to the invention is carried out preferably in two stages, i.e., stages 1 and 2, wherein the rubber composition according to the invention is preferably obtainable after going through the first stage of this two-stage process.

In the first stage (stage 1), the rubber composition according to the invention is first prepared as a base mixture (masterbatch) by mixing all constituents employed for the production of the rubber composition according to the invention with each other. In the second stage (stage 2), the constituents of the vulcanization system are admixed to the rubber composition according to the invention.

### Stage 1

Preferably, the at least one rubber contained in the rubber component of the rubber composition according to the invention, as well as resins different therefrom that may optionally be employed, preferably those that improve adhesion, are provided. However, the latter can also be added together with the other additives. Preferably, the rubbers have at least room temperature (23° C.) or are preferably employed after being preheated to temperatures of at maximum 50° C., preferably at maximum 45° C. and particularly preferably at maximum 40° C. Particularly preferably, the rubbers are pre-masticated for a short period of time before the other constituents are added. If inhibitors such as magnesium oxide are used for subsequent vulcanization control, they are preferably also added at this point of time.

Then, at least one organic filler according to the invention, and optionally further fillers, are added, preferably with the exception of zinc oxide, since this is used as a constituent of the vulcanization system in the rubber compositions according to the invention and is therefore herein not considered as a filler. The addition of the at least one organic filler according to the invention and optionally other fillers is preferably carried out in increments.

Advantageously, but not mandatorily, softening agents and other constituents such as stearic acid and/or zinc stearate and/or zinc oxide, are added only subsequently to the addition of the at least one organic filler according to the invention, or of the other fillers, if used. This facilitates the incorporation of the at least one organic filler according to the invention, and if present, the other fillers. It may be advantageous, however, to incorporate a part of the organic filler according to the invention, or, if present, the other fillers, together with the softening agents and any other constituents optionally used.

The highest temperatures obtained during the production of the rubber composition in the first stage (“dump temperature”) should not exceed 170° C., since there is the possibility of partial decomposition of the reactive rubbers and/or the organic fillers according to the invention above these temperatures. Depending in particular from the rubber employed, temperatures of >170° C., for example up to <200° C., may however also be possible. Preferably, the maximum temperature in the production of the rubber composition of the first stage is between 80° C. and <200° C., particularly preferably between 90° C. and 190° ° C., most preferably between 95° C. and 170° C.

The mixing of the constituents of the rubber composition according to the invention is usually carried out by means of internal mixers equipped with tangential or meshing (i.e., intermeshing) rotors. The latter usually allow for better temperature control. Mixers with tangential rotors are also referred to as tangential mixers. However, mixing can also be carried out using a double-roll mixer, for example.

After the preparation of the rubber composition, it is preferably cooled down before carrying out the second stage. A process of this type is also referred to as maturing. Typical maturing periods are 6 to 24 hours, preferably 12 to 24 hours.

### Stage 2

In the second stage, the constituents of the vulcanization system are incorporated into the rubber composition of the first stage, whereby a vulcanizable rubber composition according to the present invention is obtained.

If a vulcanization system based on at least zinc oxide and at least sulfur is used as the vulcanization system, at least the sulfur and the other optional constituents, such as in particular at least one thiuram and/or at least one sulfenamide, are preferably added in stage 2. It is possible to add zinc oxide, and furthermore optionally at least one saturated fatty acid, such as stearic acid, also in step 2. However, it is preferred to integrate these components into the rubber composition according to the invention already in step 1.

The highest temperatures obtained during the preparation of the admixture of the vulcanization system to the rubber composition in the second stage (“dump temperature”) should preferably not exceed 130° C., and particularly preferably not exceed 125° C. A preferred temperature range is between 70° C. and 125° C., particularly preferably 80° C. and 120° C. At temperatures above the maximal temperature for the cross-linking system of 105° C. to 120° C., premature vulcanization might occur.

After admixing the vulcanization system in stage 2, the composition is preferably cooled down.

In the above-mentioned two-stage process, a rubber composition according to the invention is thus first obtained in the first stage, which is supplemented in the second stage to form a vulcanizable rubber composition.

### Process for Further Processing the Vulcanizable Rubber Composition According to the Invention

Before vulcanization, the vulcanizable rubber compositions thus produced go through deformation processes that are preferably customized or tailored for the final articles. Rubber compositions are formed into a suitable shape as required for the vulcanization process, preferably by extrusion or calendering. In the process, vulcanization may be carried out in vulcanization molds by means of pressure and temperature, or the vulcanization is carried out without pressure in temperature-controlled channels in which air or liquid materials provide heat transfer.

### Vulcanized Rubber Composition According to the Invention

Another subject matter of the present invention is a vulcanized rubber composition that can be obtained by a vulcanization of the vulcanizable rubber composition according to the invention or by vulcanization of a vulcanizable rubber composition obtainable by combining and mixing the two parts (A) and (B) of the kit of parts according to the invention.

All preferred embodiments described hereinabove in connection with the modified organic filler according to the invention, the rubber composition according to the invention, the vulcanizable rubber composition according to the invention and the kit of parts according to the invention, as well as with the process according to the invention, are also preferred embodiments with regard to the vulcanized rubber composition according to the invention.

Typically, vulcanization is carried out under pressure and/or under heat. Suitable vulcanization temperatures are preferably from 140° C. to 200° C., particularly preferably from 150° ° C. to 180° C. Optionally, vulcanization is carried out at a pressure in the range from 50 to 175 bar. It is however also possible to carry out the vulcanization in a pressure range from 0.1 to 1 bar, for example in the case of profiles.

### Use According to the Invention

Another subject matter of the present invention is a use of at least one organic filler according to the invention for the production of rubber compositions and vulcanizable rubber compositions for employment in the production of tires, preferably pneumatic tires and solid tires, in particular pneumatic tires, preferably for the tread, sidewall and/or inner liner thereof, respectively, and/or in the production of technical rubber articles, preferably profiles, seals, dampers and/or hoses.

All preferred embodiments described hereinabove in connection with the modified organic filler according to the invention, the rubber composition according to the invention, the vulcanizable rubber composition according to the invention, the kit of parts according to the invention, the process according to the invention and the vulcanized rubber composition according to the invention are also preferred embodiments with regard to the abovementioned use according to the invention.

The term “technical rubber articles” (also mechanical rubber goods, MRG) is known to the person skilled in the art. Examples for technical rubber articles are profiles, seals, dampers and hoses.

Process for Producing a Pneumatic Tire that Preferably Comprises a Tread Made of the Vulcanizable Rubber Composition According to the Invention

Another subject matter of the present invention is a process for producing a pneumatic tire that preferably comprises a tread made of the vulcanizable rubber composition according to the invention.

The tread bands are typically vulcanized under pressure and/or heat, together with the tire carcass and/or the other tire components.

Suitable vulcanization temperatures are preferably from 140° C. to 200° C., particularly preferably from 150° C. to 180° C.

The process can be carried out, for example, in such a way that by closing the press, the green tire is molded into the closing mold. For this purpose, an inner bellows (heating bellows) can be pressurized with a small pressure (<0.2 bar) so that the bellows also fits into the green tire. After that, the press and thus the mold are completely closed. The pressure in the bellows is increased (to shaping pressure, usually approx. 1.8 bar). Thereby, the profile is imprinted into the tread, as well as the sidewall labeling. In the next working step, the press is locked and the clamping force is applied. The clamping force varies depending on the press type and the tire size and can reach up to 2,500 kN using hydraulic cylinders. After the closing forces have been applied, the actual vulcanization process starts. In the process, the mold is continuously heated with steam from the outside. During this, the temperatures are usually set to between 150 and 180° C. For the inner medium, there are very different variants depending on the tire type. For example, steam or hot water is used inside the heating bellows. The internal pressures can vary and differ according to tire types, such as car or truck tires.

### Determination Methods

### 1. Determination of the BET and STSA Surface Area of the Organic Fillers

The specific surface area of the filler to be investigated was determined by nitrogen adsorption according to the ASTM D 6556 (2019-01-01) standard provided for industrial carbon blacks. According to this standard, the BET surface area (specific total surface area according to Brunauer, Emmett and Teller) and the external surface area (STSA surface area; Statistical Thickness Surface Area) were determined as follows.

The sample to be analyzed was dried to a dry matter content >97.5% by weight at 105° C. prior to the measurement. In addition, the measuring cell was dried in a drying oven at 105° C. for several hours before weighing in the sample. The sample was then filled into the measuring cell using a funnel. In case of contamination of the upper measuring cell shaft during filling, it was cleaned using a suitable brush or a pipe cleaner. In the case of strongly flying (electrostatic) material, glass wool was weighed in additionally into the sample. The glass wool was used to retain any material that might fly up during the bake-out process and contaminate the unit.

The sample to be analyzed was baked out at 150° C. for 2 hours, and the Al₂O₃ standard was baked out at 350° C. for 1 hour. The following N2 dosage was used for the determination, depending on the pressure range:
p/p0=0-0.01: N₂ dosage: 5 ml/g
p/p0=0.01-0.5: N₂ dosage: 4 ml/g.

To determine the BET, extrapolation was performed in the range of p/p0=0.05-0.3 with at least 6 measurement points. To determine the STSA, extrapolation was performed in the range of the layer thickness of the adsorbed N2 from t=0.4-0.63 nm (corresponding to p/p0=0.2-0.5) with at least 7 measurement points.

### 2. Determination of the Ash Content of the Organic Fillers

The water-free ash content of the samples was determined by thermogravimetric analysis in accordance with the DIN 51719 standard as follows: Before weighing, the sample was ground or mortared. Prior to ash determination, the dry substance content of the weighed-in material is determined. The sample material was weighed to the nearest 0.1 mg in a crucible. The furnace, including the sample, was heated to a target temperature of 815° C. at a heating rate of 9° K/min and then held at this temperature for 2 h. The furnace was then cooled to 300° C. before the samples were taken out. The samples were cooled to ambient temperature in the desiccator and weighed again. The remaining ash was correlated to the initial weight and thus the weight percentage of ash was determined. Triplicate determinations were performed for each sample, and the averaged value was reported.

### 3. Determination of the pH Value of the Organic Fillers Employed

The pH was determined following ASTM D 1512 standard as follows. The dry sample, if not already in powder form, was mortared or ground to a powder. In each case, 5 g of sample and 50 g of fully deionized water were weighed into a glass beaker. The suspension was heated to a temperature of 60° C. with constant stirring using a magnetic stirrer with heating function and stirring flea, and the temperature was maintained at 60° C. for 30 min. Subsequently, the heating function of the stirrer was deactivated so that the mixture could cool down while stirring. After cooling, the evaporated water was replenished by adding fully deionized water again and stirred again for 5 min. The pH value of the suspension was determined with a calibrated measuring instrument. The temperature of the suspension should be 23° C. (±0.5° C.). A duplicate determination was performed for each sample and the averaged value was reported.

### 4. Determination of Heat Loss of the Organic Fillers Employed

The heat loss of the sample was determined along the lines of ASTM D 1509 as follows. For this purpose, the MA100 moisture balance from the company Sartorius was heated to a dry temperature of 125° C. The dry sample, if not already in powder form, was mortared or ground to a powder. Approximately 2 g of the sample to be measured was weighed on a suitable aluminum pan in the moisture balance and then the measurement was started. As soon as the weight of the sample did not change by more than 1 mg for 30 s, this weight was considered constant and the measurement was terminated. The heating loss then corresponds to the displayed moisture content of the sample in % by weight. At least one duplicate determination was performed for each sample. The weighted mean values were reported.

### 5. Determination of OH Groups Available on the Surface (OH Group Density)

Determination of the acidic hydroxyl groups available on the surface, including phenolic OH groups and phenolate groups, was carried out qualitatively and quantitatively colorimetrically according to Sipponen. The method according to Sipponen is based on the adsorption of the alkaline dye Azure B to the acidic hydroxyl groups accessible on the filler surface, and is described in detail in the paper “Determination of surface-accessible acidic hydroxyls and surface area of lignin by cation dye adsorption” (Bioresource Technology 169 (2014) 80-87). The amount of the acidic hydroxyl groups available on the surface is given in mmol/g of filler. Regardless of how the filler was obtained, the process was applied not only to lignin-based fillers but also to the comparative carbon black N660, for example.

### 6. Determination of the ¹⁴C Content

The determination of the ¹⁴C content (content of biologically based carbon) can be carried out by means of the radiocarbon method according to DIN EN 16640:2017-08.

### 7. Determination of Carbon Content

The carbon content can be determined by elementary analysis according to DIN 51732:2014-7.

### 8. Determination of Oxygen Content

The oxygen content can be determined by high-temperature pyrolysis using the EuroEA3000 CHNS-O Analyzer of the company EuroVector S.p.A.

### 9. Determination of Solubility in Alkaline Media

Determination of the alkaline solubility is carried out as follows:

The solubility is determined in triplicate. For this purpose, 2.0 g of dry filler each are weighed into 20 g 0.1 M NaOH each, respectively. If the determined pH value of the sample however is <10, the sample is discarded, and 2.0 g of dry filler are weighed into 20 g 0.2 M NaOH each instead. In other words, depending from the pH value (<10 or ≥10), either 0.1 M NaOH is used (pH≥10) or 0.2 M NaOH (pH<10) is used. The alkaline suspension is shaken at room temperature for 2 hours, at a shaker rate of 200 per minute. If the liquid should contact the lid in the process, the shaker rate has to be reduced to prevent this from happening. Then, the alkaline suspension is centrifuged at 6,000×g. The supernatant of the centrifugation is filtered through a Por 4 frit. The solid after centrifugation is washed twice with distilled water, while the centrifugation and filtration described above is repeated after each washing. The solid is dried in the drying oven for at least 24 h at 105° C. until the weight remains constant. The alkaline solubility of the solid matter is calculated as follows:

$$Alkaline solubility of the solid matter [ \% ] = Mass of the undissolved proportion after centrifugation , filtration and drying [ g ] * 100 / mass of the starting product [ g ]$$

1. An organic filler with a ¹⁴C content in a range from 0.20 to 0.45 Bq/g carbon which has acidic OH groups, wherein at least a part of the acidic OH groups are phenolic OH groups,
wherein a covalent bonding of at least one organic modifier to the organic filler has been effected at least via a part of the oxygen atoms of at least one functional group of the filler which is selected from phenolic OH groups, phenolate groups, aliphatic OH groups, carboxylic acid groups, carboxylate groups and mixtures thereof, wherein the bonding has not taken place in the presence of a rubber,
wherein the at least one organic modifier employed is an organosilane that has at least one organic radical and at least one hydrolyzable functional group X that is reactive with the at least one functional group of the filler by means of which the bonding to the filler has taken place,
and wherein the organic filler has a BET surface area in a range from 10 to <200 m²/g.

2. The filler according to claim 1 being present in rubber-free form.

3. The filler according to claim 1, comprising a BET surface area in a range from 10 to 150 m²/g, and/or the filler is a lignin-based filler, wherein optionally at least the lignin is present at least partially in a form that can be obtained by means of hydrothermal treatment.

4. The filler according to claim 1, wherein the at least one organic modifier is at least one monosilane, which optionally has at least two hydrolyzable groups X, and/or is at least one bis(silane), which optionally has at least four hydrolyzable groups X, wherein the hydrolyzable groups X are alkoxy groups and/or halide groups.

5. The filler according to claim 1, wherein the at least one organic modifier:
has at least one other functional group FGK that is different from the at least one reactive functional group X which is optionally part of the at least one organic radical of the modifier, and that—when the filler is employed together with at least one rubber within a rubber composition—shows reactivity with the at least one rubber and/or with at least one functional group of this rubber and/or with at least one vulcanization system present in the rubber composition, in particular during a vulcanization, wherein the at least one other functional group FGK is selected from the group consisting of carbon-carbon double bonds, peroxide groups and sulfur-containing groups, as well as mixtures thereof, and/or
has at least one other functional group FGB that is different from the at least one reactive functional group X, and is also different from the other functional group FGK optionally present, wherein the at least one other functional group FGB is a functional group which increases the basicity of the filler after bonding of the organic modifier, optionally is an amino group.

6. The filler according to claim 1, which is obtained by performing at least one step (a) and optionally one or more of steps (b) to (d) as follows:
(a) bringing together the at least one organic modifier and at least one organic filler FPM which has a ¹⁴C content in a range from 0.20 to 0.45 Bq/g carbon and which has at least one functional group that is selected from phenolic OH groups, phenolate groups, aliphatic OH groups, carboxylic acid groups, carboxylate groups and mixtures thereof,
(b) optionally heating the mixture obtained according to step (a), which is optionally present within a liquid or gaseous reaction medium,
(c) after the covalent bonding of the modifier to the filler FPM at least via a part of the oxygen atoms of the at least one functional group of the filler FPM, optionally extracting at least one organic solvent, if the bringing together according to step (a) and the optional heating according to step (b) was performed in a liquid reaction medium that contains at least one organic solvent, and
(d) after the covalent bonding of the modifier to the filler FPM, optionally drying the product obtained after performing step (a) and optionally step (b) and/or (c), optionally under vacuum and/or at a temperature in a range from 20 to 100° C.

7. The filler according to claim 1, presenting free phenolic OH groups and/or phenolate groups and/or aliphatic OH groups and/or carboxylic acid groups and/or carboxylate groups after the covalent bonding of the at least one modifier has been effected.

8. The filler according to claim 1, wherein the at least one organic modifier is at least one organosilane of the general formula (I) and/or (II), 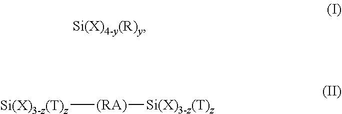
wherein, in the case of the general formula (I),
X respectively and independently from one another represents a hydrolyzable functional group that is reactive with phenolic OH groups, phenolate groups, aliphatic OH groups, carboxylic acid groups, carboxylate groups and/or mixtures thereof, and that respectively and independently from one another is selected from O—C₁₋₄ alkyl and halides, the parameter y represents an integer in the range from 1 to 3, and
R represents a non-hydrolyzable organic radical, preferably a C₃-C₂₀ aliphatic radical, which optionally contains at least one reactive functional group FGK selected from the group consisting of carbon-carbon double bonds, peroxide groups and sulfur-containing groups, as well as mixtures thereof, and/or FGB different from the other functional group FGK optionally present, wherein the at least one other functional group FGB is a functional group which increases the basicity of the filler after bonding of the organic modifier, optionally is an amino group, and
wherein, in the case of the general formula (II),
X respectively and independently from one another represents a hydrolyzable functional group that is reactive with phenolic OH groups, phenolate groups, aliphatic OH groups, carboxylic acid groups, carboxylate groups and/or mixtures thereof, and that respectively and independently from one another is selected from O—C₁₋₄ alkyl and halides, RA represents a non-hydrolyzable organic radical with two bonds, optionally containing at least one reactive functional group the FGK and/or the FGB, and
the parameter z respectively represents an integer in the range from 0 to 3, and T represents a non-hydrolyzable organic radical that is different from the radical (RA) and optionally has no functional groups FGB and FGK.

9. A rubber composition, comprising at least one rubber component that contains at least one rubber, and a filler component, wherein the filler component contains at least one organic filler according to claim 1.

10. The rubber composition according to claim 9, wherein the at least one rubber is selected from the group consisting of natural rubber (NR), halobutyl rubbers, butyl rubber or isobutylene-isoprene rubber (IIR; also isobutene-isoprene rubber), styrene-butadiene rubber (SBR), polybutadiene (BR, butadiene rubber), acrylonitrile-butadiene rubbers (NBR, nitrile rubber) and/or HNBR (hydrated NBR), chloroprene (CR), polyisoprene (IR), ethylene-propylene-diene rubber (EPDM), and mixtures thereof.

11. The rubber composition according to claim 9 wherein the at least one organic filler according to is present in a quantity in a range from 10 to 150 phr.

12. A vulcanizable rubber composition, comprising the rubber composition according to claim 9 and a vulcanization system that comprises at least zinc oxide and/or at least sulfur and/or at least one peroxide, and.

13. A kit of parts, comprising, in spatially separated form, as part (A) a rubber composition according to claim 9, and as part (B) a vulcanization system comprising at least zinc oxide and/or at least sulfur and/or at least one peroxide.

14. A vulcanized rubber composition, which is obtainable by a vulcanization of the vulcanizable rubber composition according to claim 12.

15. A method for production of rubber compositions and vulcanizable rubber compositions for employment in the production of tires including pneumatic tires and/or solid tires comprising: mixing the organic filler according to claim 1 with one or more rubber ingredients.

16. The filler according to claim 3, wherein the organic filler can be obtained by hydrothermal treatment.

17. The filler according to claim 6, wherein the heating of optional step (b) is conducted at a temperature in a range of 30° C. to 190° C.

18. A vulcanized rubber composition, which is obtainable by vulcanization of a vulcanizable rubber composition obtainable by combining and mixing both parts (A) and (B) of the kit of parts according to claim 13.

19. The method according to claim 15, wherein the production of tires includes: the production of tread, sidewall and/or inner liner thereof, and/or for employment in the production of technical rubber articles.
